(19) United States
(12) Patent Application Publication
(10) Pub. No.: US 2026/0362212 A1
(43) Pub. Date: Nov. 12, 2026

(54) CONTEXTUALIZED-BASED NETWORK SLICE MANAGEMENT

(71) Applicant: T-Mobile USA, Inc., Bellevue, WA (US)

(72) Inventors: Ryan Christopher Lindstrom, De Soto, KS (US); George Jason Schnellbacher, Leawood, KS (US); Matthew John Starzec, Leesburg, WA (US)

(21) Appl. No.: 19/205,527

(22) Filed: May 12, 2025

(51) Int. Cl. H04W 28/02

(52) U.S. Cl. CPC H04W 28/0231; H04W 28/0226; H04W 28/0268

(57) ABSTRACT

The system determines a user association of a wireless device connected to a first network slice on a network node of a telecommunication network. The system predicts, using a machine learning model, a bandwidth demand on the first network slice based on a time of day, day of the week, or geographic location. The system generates a prioritization order for the wireless device based on the user association of the wireless device and the predicted bandwidth demand on the first network slice. The system causes the network node to implement the prioritization order. The system causes the network node to provision the wireless device to a second network slice when the predicted bandwidth demand or an actual bandwidth demand exceeds an amount of available bandwidth on the first network slice.

### BACKGROUND

Network slicing is a technology that enables the creation of multiple virtual networks on a shared physical infrastructure. These virtual networks, or slices, can be customized to meet specific performance requirements for different applications and services. Network slicing allows network operators to efficiently allocate bandwidth and provide tailored connectivity for diverse use cases such as enhanced mobile broadband, massive machine-type communications, and ultra-reliable low-latency communications.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an embodiment of the system.

FIG. 4 is a flow diagram that illustrates an embodiment of the system.

FIG. 5 is a block diagram that illustrates an example of a computer system in which at least some operations described herein can be implemented.

FIG. 6 is a block diagram illustrating an example machine learning system, in accordance with one or more embodiments.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to contextualized network slice management on a network node of a telecommunication network. Network slicing enables operators to create multiple virtual networks on shared physical infrastructure, with each slice customized for specific performance requirements (e.g., increased amounts of bandwidth or increased bandwidth speed). For example, the telecommunication network typically generates network slices for specific applications (e.g., streaming, virtual reality, live streaming) or for specific large events (e.g., concerts, sporting events, and/or conferences). The bandwidth availability on these network slices can vary dynamically based on factors such as network load, bandwidth utilization, and user demand. This causes wireless devices connected to a network slice to experience reduced bandwidth and/or reduced data speeds, leading to a decrease in the overall user experience on the telecommunication network and an interruption to the services subscribed to.

Typically, priority on a network slice is determined by a wireless device's subscriber status (e.g., customers who pay more have higher priority) and/or how long a wireless device has been connected to the network slice (e.g., first come, first served). Therefore, there is no way to differentiate wireless devices of the same subscriber tier for determining a priority order on the network slice. During times of high bandwidth usage, such as during concerts, sporting events, or New Year's Eve, certain user associations (e.g., first responders or event workers) can experience detrimental service interruptions, preventing the users from properly performing their jobs. These service interruptions are also unlikely to be resolved until the wireless device connects to a different network node or other wireless devices disconnect from the network node.

The disclosed technology is a system that monitors the network slice to determine a user association of the wireless device to determine what position to place the wireless device on a priority order for the network slice to prevent service interruptions. The system determines a user association of each wireless device connected to a network slice of a network node. For example, the user association could be a fireman, a paramedic, a first responder, and/or not applicable (e.g., the wireless device is not connected to a user association with an increased priority indicator). The system uses a machine learning (ML) model to predict a resource demand on the network slice based on the network conditions (e.g., time of day, location, etc.). The system then generates a prioritization order to rank each wireless device on the network slice. For example, wireless devices with a user association of first responders and/or doctors can be prioritized by being ranked higher on the prioritization order. In some implementations, workers at a sporting event are prioritized but only within the set geographic region of the event venue. The system itself can implement or cause the network node to implement the prioritization order. As part of the prioritization order, the system can provision or cause the network node to provision one or more wireless devices to a different network slice to alleviate bandwidth issues and rectify any user experience issues on the network slice. The system, therefore, alleviates bandwidth issues on network slices while also ensuring that the proper wireless devices have the appropriate access to bandwidth on the network slice.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

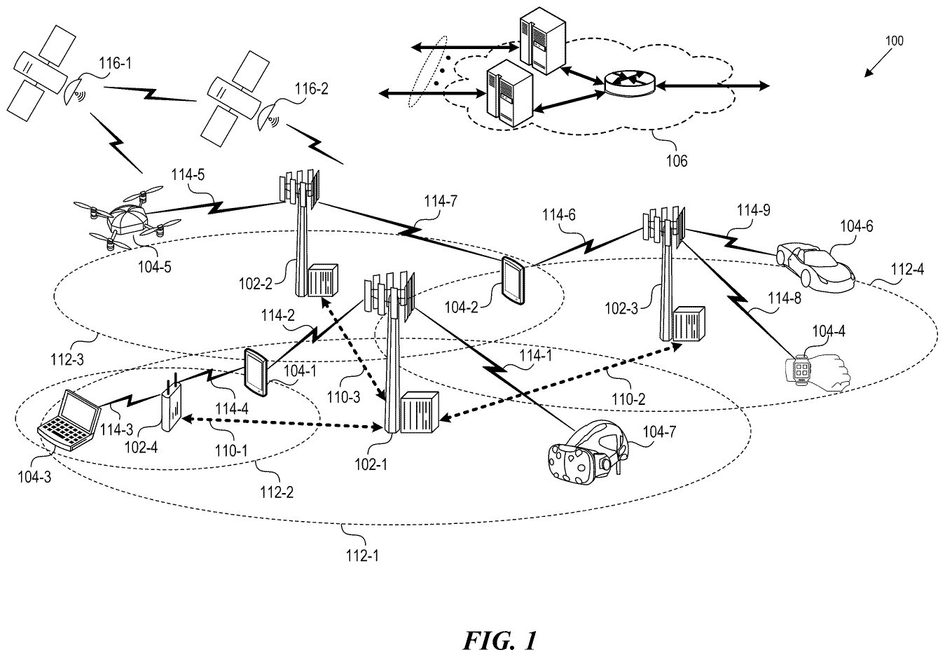

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

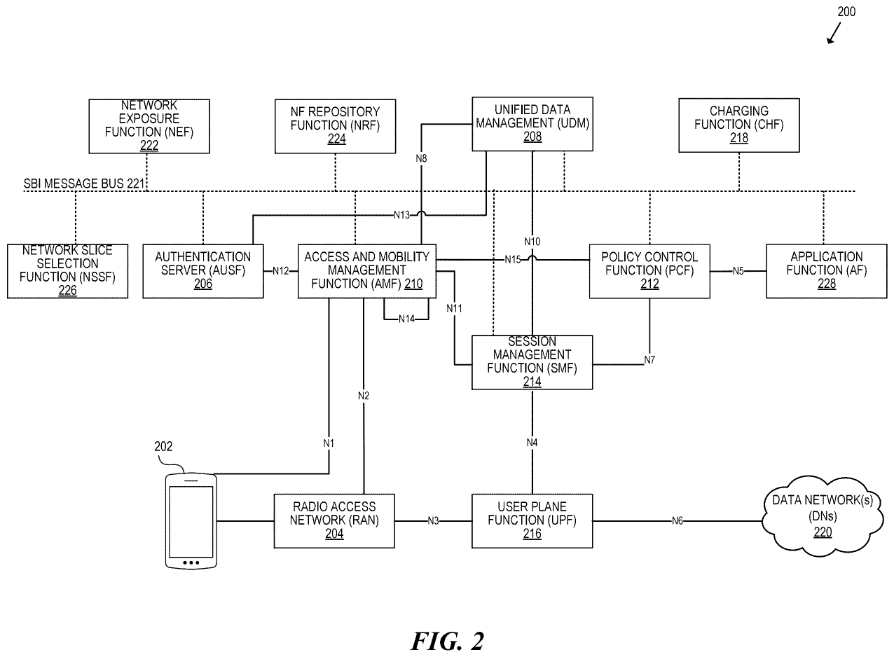

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Network Slice Management

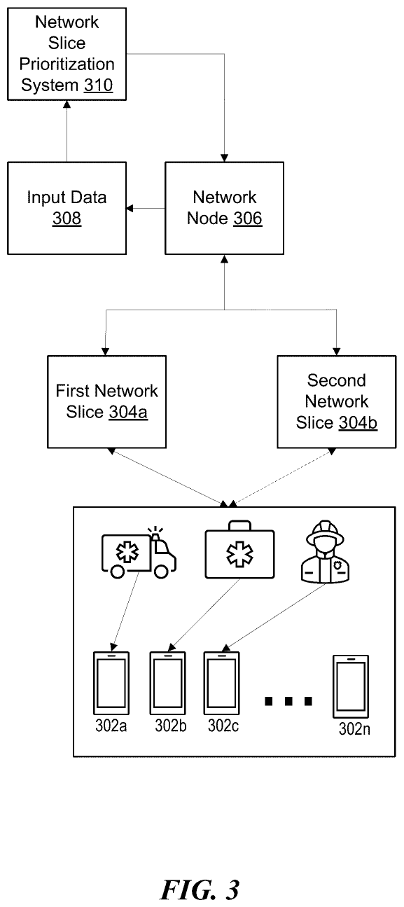

FIG. 3 is a block diagram that illustrates an embodiment of the network slice prioritization system 310 (system 310). The telecommunication network can include a network node 306. Network node 306 can include multiple network slices—for example, a first network slice 304a and a second network slice 304b. Multiple wireless devices 302a, 302b, 302c, 302n can be connected to a single network slice (e.g., either the first network slice 304a or the second network slice 304b). Each wireless device 302a, 302b, 302c, 302n can have a base ranking or priority on a network slice. For example, a first wireless device 302a can have the highest ranking, indicating priority access to bandwidth on the network slice 304a, 304b when compared to a lower ranking on the network slice 304a, 304b. A second wireless device 302b can have the second highest ranking, then a third wireless device 302c can have a ranking after the second wireless device, down to an nth wireless device 302n, which can have the lowest ranking on the network slice 304a, 304b. The initial ranking is determined by each wireless device's subscriber status (e.g., wireless devices 302a, 302b, 302c, 302n that pay more have higher priority) and/or how long a wireless device 302a, 302b, 302c, 302n has been connected to the network slice (e.g., first come, first served).

The input data 308 is generated based on each wireless device's interactions with the network node. The input data 308 can include data related to key performance indicators (KPI) that are indicative of a user association, a use case of each wireless device 302a, 302b, 302c, 302n, a user experience level of each wireless device 302a, 302b, 302c, 302n, and/or current network conditions that can be indicative of bandwidth demand on the network slice. For example, the KPI data can indicate that the wireless device is being used by a first responder and/or being used to notify a first responder. The input data 308 can include subscriber-level data, such as subscriber name, occupation, and/or affiliation (e.g., John Smith, first responder, and/or hospital X). In some embodiments, each wireless device 302a, 302b, 302c, 302n transmits codes, data, and/or some other indicator value to the network node so as to notify the system 310 of the user association. The input data 308 also includes location data for each wireless device 302a, 302b, 302c, 302n. For example, the location data can be generated using global positioning data generated by the wireless device itself or triangulation by the network node.

So the system can predict the bandwidth demand on the network node and whether a certain user association needs to be prioritized, the input data can include data related to Reference Signal Received Power (RSRP), latency, resource block utilization, signal strength, interference levels, packet processing rates, NF performance, backhaul capacity utilization, throughput, packet loss, resource consumption, and/or any other KPI that is affected by bandwidth utilization on the network slice.

RSRP is a measurement of the strength of a wireless signal in a cell network and is used to evaluate network coverage and communication stability. Latency is the delay in network communication and shows the time that data takes to transfer across the network. Resource block utilization refers to how efficiently a network's resources, specifically resource blocks (RBs), are being used to serve users, often measured as the percentage of available RBs that are actively transmitting data. Signal strength refers to the transmitter power output as received by a reference antenna at a distance from the transmitting antenna. Interference refers to unwanted signals that disrupt communication, and interference levels can be measured using metrics like signal-to-interference-plus-noise ratio (SINR) and signal-to-noise ratio (SNR). Packet processing rates are the speed at which network devices, like routers and switches, can process and forward data packets. Network function performance is the measurement and evaluation of how well individual network functions (like routers, firewalls, or load balancers) and the overall network infrastructure are performing. Throughput is the actual amount of data successfully transferred over a network connection within a specific time period. Packet loss occurs when data transmitted over a network fails to reach the intended destination. Resource consumption is the amount of network elements (like bandwidth, CPU, memory, etc.) and/or energy used by the telecommunication network or network node.

The input data 308 is received by the system 310 at regular intervals (e.g., when data is generated and/or every 1, 5, 10, 15, or 30 minutes). The system 310 is configured to perform contextualized prioritization on network slices to ensure that certain user associations do not experience user experience issues or service interruptions. Contextualized prioritization refers to adjusting the prioritization or ranking of the wireless devices 302a, 302b, 302c, 302n connected to a network slice 304a, 304b based on factors such as geographic location, time of day, day of the week, and/or wireless device user association.

Geographic location refers to a physical location of the wireless device. For example, in areas with high population density, known congestion hotspots, or large events, the system 310 adjusts the prioritization order to favor certain user associations or groups of people (e.g., first responders, doctors, event workers, etc.) while a wireless device 302a, 302b, 302c, 302n associated with that group of users is positioned in the issue area. The system 310 can determine which geographic locations are in need of prioritization based on historical KPI data, current KPI data for that location, web scraping, and/or network-defined lists.

The system 310 accounts for time-based factors such as time of day or day of the week due to how bandwidth demand on the network slice changes with time. For example, the system can determine that holidays such as New Year's Eve between the hours of 6 p.m. and 2 a.m. will have an increased demand when compared to a typical night between those hours. The system 310 can also determine that a business district during regular business hours will have increased amounts of bandwidth utilization. Conversely, the system can determine that during evening hours, residential areas will have an increased amount of bandwidth utilization. Additionally, the system can determine that bandwidth utilization for certain areas changes from day to day—for example, that a Saturday will have a different bandwidth utilization trend compared to a Wednesday. The system 310 can determine the time-based factors based on current and historical KPI data, web scraping, and/or network-defined lists. By using these time-based factors, the system is able to better account for changing conditions, reducing the amount of wasted resources.

User association refers to the occupation and/or affiliation of the user of the wireless device 302a, 302b, 302c, 302n. For example, the system can prioritize wireless devices 302a, 302b, 302c, 302n associated with emergency services. For example, the first wireless device 302a can be associated with a paramedic or ambulance service. The system 310 can prioritize the first wireless device 302a at all times or at certain times based on the day of the week or geographic location of the first wireless device 302a. The second wireless device 302b can be associated with a doctor. The system 310 can prioritize the second wireless device when the second wireless device 302b is at a hospital and/or when an indication is received that the doctor is on call. The third wireless device 302c can be associated with a fireman and/or a firetruck. The system 310 can prioritize the third wireless device 302c at all times, when the wireless device 302c is located at a fire station, and/or when an indication is received that the fireman is responding to a fire event.

The system 310 can dynamically adjust the prioritization of the first, second, and third wireless devices 302a, 302b, 302c based on a predicted demand on the network slice 304a, 304b. For example, the first wireless device 302a can have a baseline prioritization above the second and third wireless devices 302b, 302c. During a fire event, the system 310 can adjust the priority order so that the third wireless device 302c is above the first wireless device 302a and then deprioritize the third wireless device 302c when the fire event is resolved and the third wireless device 302c returns to the fire station. The third wireless device 302c, or any wireless device 302a, 302b, 302c, 302n, can be prioritized by being provisioned to the second network slice 304b to increase the available bandwidth for the provisioned wireless device 302a, 302b, 302c, 302n and/or decrease the bandwidth utilization on the first network slice 304a. The second network slice 304b can have increased amounts of bandwidth when compared to the first network slice 304a.

In some embodiments, the system 310 uses a machine learning (ML) model to determine when and which wireless devices 302a, 302b, 302c, 302n to prioritize on the network slice. For example, the ML model can factor in input data 308 such as that relating to historical usage patterns for different locations and time periods, current network load and available resources, upcoming events or known factors that could impact demand, user profiles and preferences, and/or service-specific requirements (e.g., latency, bandwidth, reliability) when making a resource demand prediction and decision on how to adjust the prioritization order on a network slice 304a, 304b. The ML model is capable of detecting a user association for wireless devices subscribed to and/or subscribed to different telecommunication networks (e.g., the wireless device has a roaming status on the network node). This ensures all wireless devices having a certain user association are properly prioritized on the network slice 304a, 304b. The ML model receives the input data 308, determines a priority order for the network node 306, and then causes the system 310 or the network node 306 to implement the priority order. The ML model can be specifically trained using historical and current input data 308 and/or a pre-created training dataset.

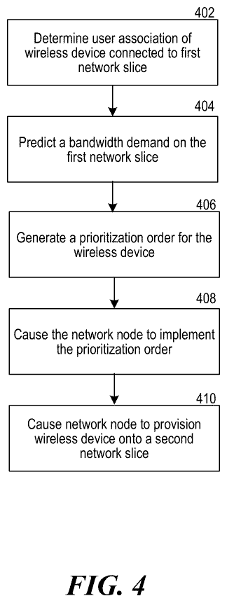

FIG. 4 is a flowchart that illustrates an embodiment of the system. Process 400 can be performed by a system of a telecommunication network. In one example, the system includes at least one hardware processor and at least one non-transitory memory storing instructions, which, when executed by at least one hardware processor, cause the system to perform the process 400.

At 402, the system determines a user association of a wireless device connected to a first network slice on a network node of a telecommunication network. At 404, the system predicts, using a machine learning model, a bandwidth demand on the first network slice based on a time of day, day of the week, or geographic location. In some embodiments, when predicting the bandwidth demand on the first network slice, the system receives key performance indicator data from the network node that is indicative of the bandwidth demand on the first network slice. The key performance indicator data relates to latency, signal strength, packet loss, or interference levels experienced by the at least one wireless device. The system compares the received key performance indicator data to historical key performance indicator data.

At 406, the system generates a prioritization order for the wireless device based on the user association of the wireless device and the predicted bandwidth demand on the first network slice. At 408, the system causes the network node to implement the prioritization order. In some embodiments, the system determines, based on location data of the wireless device, that the wireless device is entering a predefined geographic area. The system causes the network node to increase a position of the wireless device on the prioritization order when the location data indicates that the wireless device is located in the predefined geographic area. The system causes the network node to return the wireless device to a previous position on the prioritization order when the location data indicates the wireless device is located outside the predefined geographic location.

In some other embodiments, the system determines, based on key performance indicator data on the network node, an actual bandwidth demand above the predicted bandwidth demand and causes the network node to increase a position of the wireless device on the prioritization order. In yet some other embodiments, the system updates the prioritization order based on a change to the predicted bandwidth demand on the first network slice.

At 410, the system causes the network node to provision the wireless device to a second network slice when the predicted bandwidth demand or an actual bandwidth demand exceeds an amount of available bandwidth on the first network slice. In some embodiments, the system categorizes each user association based on a baseline position on the prioritization order, where a first category of user associations has a higher baseline position on the prioritization order when compared to a second category. When the wireless device is categorized into the first category, the system can assign the wireless device a highest priority on the first network slice and cause the network node to provision the wireless device to the second network slice of the network node when the predicted demand reaches a threshold value. The threshold value is less than a total amount of resources available on the network slice. When the wireless device is a first wireless device and wherein the first wireless device is categorized into the first category, the system can generate an updated prioritization order, wherein the updated prioritization order, a second wireless device categorized into the second category has a higher position on the prioritization order than the first wireless device. The system can cause the network node to implement the updated prioritization order and can cause the network node to re-implement the prioritization order after a predetermined amount of time.

In some other embodiments, the system determines, based on location data of the wireless device, that the wireless device is entering a predefined geographic area. The system causes the network node to increase a position of the wireless device on the prioritization order when the location data indicates that the wireless device is located in the predefined geographic area. The system causes the network node to return the wireless device to a previous position on the prioritization order when the location data indicates the wireless device is located outside the predefined geographic location.

### Computer System

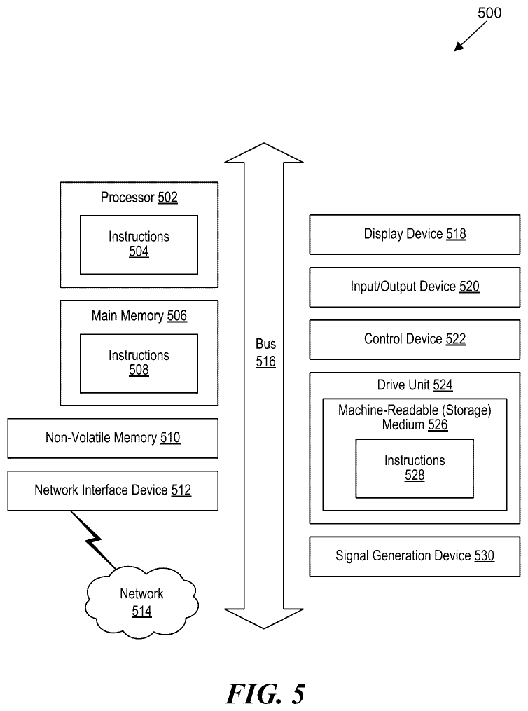

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Machine Learning Model

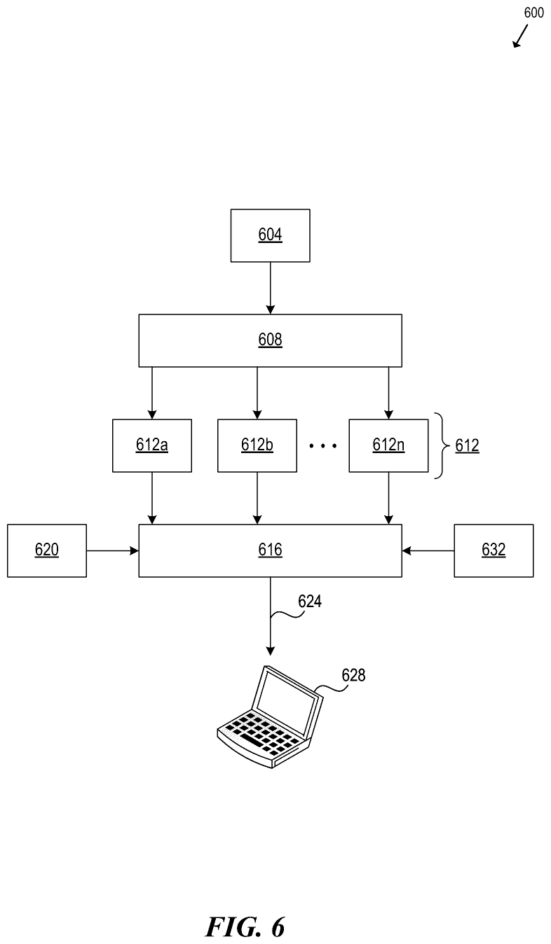

FIG. 6 is a block diagram illustrating an example ML system 600, in accordance with one or more embodiments. Likewise, different embodiments of the ML system 600 include different and/or additional components and are connected in different ways. The ML system 600 is sometimes referred to as an ML module.

The ML system 600 includes a feature extraction module 608 implemented using components of the example computer system 500 illustrated and described in more detail with reference to FIG. 5. In some embodiments, the feature extraction module 608 extracts a feature vector 612 from input data 604. The feature vector 612 includes features 612a, 612b,. 612n. The feature extraction module 608 reduces the redundancy in the input data 604, for example, repetitive data values, to transform the input data 604 into the reduced set of features 612, for example, features 612a, 612b,. 612n. The feature vector 612 contains the relevant information from the input data 604, such that events or data value thresholds of interest are identified by the ML model 616 by using a reduced representation. In some example embodiments, the following dimensionality reduction techniques are used by the feature extraction module 608: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 616 performs deep learning (also known as deep structured learning or hierarchical learning) directly on the input data 604 to learn data representations, as opposed to using task-specific algorithms. In deep learning, no explicit feature extraction is performed; the features 612 are implicitly extracted by the ML system 600. For example, the ML model 616 uses a cascade of multiple layers of nonlinear processing units for implicit feature extraction and transformation. Each successive layer uses the output from the previous layer as input. The ML model 616 thus learns in supervised (e.g., classification) and/or unsupervised (e.g., pattern analysis) modes. The ML model 616 learns multiple levels of representations that correspond to different levels of abstraction, wherein the different levels form a hierarchy of concepts. The multiple levels of representation configure the ML model 616 to differentiate features of interest from background features.

In alternative example embodiments, the ML model 616, for example, in the form of a convolutional neural network (CNN), generates the output 624, without the need for feature extraction, directly from the input data 604. The output 624 is provided to the computer device 628. The computer device 628 is a server, computer, tablet, smartphone, smart speaker, etc., implemented using components of the example computer system 500 illustrated and described in more detail with reference to FIG. 5. In some embodiments, the steps performed by the ML system 600 are stored in memory on the computer device 628 for execution. In other embodiments, the output 624 is displayed on an electronic display of the computer device 628.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 616 is a CNN that includes both convolutional layers and max pooling layers. For example, the architecture of the ML model 616 is “fully convolutional,” which means that variable-sized sensor data vectors are fed into it. For convolutional layers, the ML model 616 specifies a kernel size, a stride of the convolution, and an amount of zero padding applied to the input of that layer. For the pooling layers, the ML model 616 specifies the kernel size and stride of the pooling.

In some embodiments, the ML system 600 trains the ML model 616, based on the training data 620, to correlate the feature vector 612 to expected outputs in the training data 620. As part of the training of the ML model 616, the ML system 600 forms a training set of features and training labels by identifying a positive training set of features that have been determined to have a desired property in question, and, in some embodiments, forms a negative training set of features that lack the property in question.

The ML system 600 applies ML techniques to train the ML model 616, that when applied to the feature vector 612, outputs indications of whether the feature vector 612 has an associated desired property or properties, such as a probability that the feature vector 612 has a particular Boolean property, or an estimated value of a scalar property. In embodiments, the ML system 600 further applies dimensionality reduction (e.g., via linear discriminant analysis (LDA), PCA, or the like) to reduce the amount of data in the feature vector 612 to a smaller, more representative set of data.

In embodiments, the ML system 600 uses supervised ML to train the ML model 616, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 632 is formed of additional features, other than those in the training data 620, which have already been determined to have or to lack the property in question. The ML system 600 applies the trained ML model 616 to the features of the validation set 632 to quantify the accuracy of the ML model 616. Common metrics applied in accuracy measurement include Precision and Recall, where Precision refers to a number of results the ML model 616 correctly predicted out of the total it predicted, and Recall is a number of results the ML model 616 correctly predicted out of the total number of features that had the desired property in question. In some embodiments, the ML system 600 iteratively re-trains the ML model 616 until the occurrence of a stopping condition, such as the accuracy measurement indication that the ML model 616 is sufficiently accurate, or a number of training rounds having taken place. In embodiments, the validation set 632 includes data corresponding to confirmed locations, dates, times, activities, or combinations thereof. This allows the detected values to be validated using the validation set 632. The validation set 632 is generated based on the analysis to be performed.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
determine a user association of a wireless device connected to a first network slice on a network node of a telecommunication network;
predict, using a machine learning model, a bandwidth demand on the first network slice based on a time of day, day of the week, or geographic location;
generate a prioritization order for the wireless device based on the user association of the wireless device and the predicted bandwidth demand on the first network slice;
cause the network node to implement the prioritization order; and
cause the network node to provision the wireless device to a second network slice when the predicted bandwidth demand or an actual bandwidth demand exceeds an amount of available bandwidth on the first network slice.

2. The non-transitory, computer-readable storage medium of claim 1, wherein the instructions further cause the system to:
categorize each user association based on a baseline position on the prioritization order,
wherein a first category of user associations has a higher baseline position on the prioritization order when compared to a second category.

3. The non-transitory, computer-readable storage medium of claim 2, wherein the wireless device is categorized into the first category, the instructions further cause the system to:
assign the wireless device a highest priority on the first network slice; and
cause the network node to provision the wireless device to the second network slice of the network node when the predicted demand reaches a threshold value,
wherein the threshold value is less than a total amount of resources available on the network slice.

4. The non-transitory, computer-readable storage medium of claim 2, wherein the wireless device is a first wireless device and wherein the first wireless device is categorized into the first category, the instructions further cause the system to:
generate an updated prioritization order,
wherein, in the updated prioritization order, a second wireless device categorized into the second category has a higher position on the prioritization order than the first wireless device;
cause the network node to implement the updated prioritization order; and
cause the network node to re-implement the prioritization order after a predetermined amount of time.

5. The non-transitory, computer-readable storage medium of claim 1, wherein the instructions further cause the system to:
determine, based on location data of the wireless device, that the wireless device is entering a predefined geographic area;
cause the network node to increase a position of the wireless device on the prioritization order when the location data indicates that the wireless device is located in the predefined geographic area; and
cause the network node to return the wireless device to a previous position on the prioritization order when the location data indicates the wireless device is located outside the predefined geographic location.

6. The non-transitory, computer-readable storage medium of claim 1, wherein the instructions further cause the system to:
determine, based on key performance indicator data on the network node, an actual bandwidth demand above the predicted bandwidth demand; and
cause the network node to increase a position of the wireless device on the prioritization order.

7. The non-transitory, computer-readable storage medium of claim 1, wherein predicting the bandwidth demand on the first network slice further causes the system to:
receive key performance indicator data from the network node that is indicative of the bandwidth demand on the first network slice,
wherein the key performance indicator data relates to latency, signal strength, packet loss, or interference levels experienced by the at least one wireless device; and
compare the received key performance indicator data to historical key performance indicator data.

8. The non-transitory, computer-readable storage medium of claim 1, wherein the instructions further cause the system to:
update the prioritization order based on a change to the predicted bandwidth demand on the first network slice.

9. A system comprising:
at least one hardware processor; and
at least one non-transitory memory storing instructions, which, when executed by the at least one hardware processor, cause the system to:
determine a user association of a wireless device connected to a first network slice on a network node of a telecommunication network;
predict, using a machine learning model, a bandwidth demand on the first network slice;
generate a prioritization order for the wireless device based on the user association of the wireless device and the predicted bandwidth demand on the first network slice;
cause the network node to implement the prioritization order; and
cause the network node to provision the wireless device to a second network slice when the predicted bandwidth demand or an actual bandwidth demand exceeds an amount of available bandwidth on the first network slice.

10. The system of claim 9, further caused to:
categorize each user association based on a baseline position on the prioritization order,
wherein a first category of user associations has a higher baseline position on the prioritization order when compared to a second category.

11. The system of claim 10, wherein the wireless device is categorized into the first category, the system further caused to:
assign the wireless device a highest priority on the first network slice; and
cause the network node to provision the wireless device to the second network slice of the network node when the predicted demand reaches a threshold value,
wherein the threshold value is less than a total amount of resources available on the network slice.

12. The system of claim 10, wherein the wireless device is a first wireless device and wherein the first wireless device is categorized into the first category, the system further caused to:
generate an updated prioritization order,
wherein, in the updated prioritization order, a second wireless device categorized into the second category has a higher position on the prioritization order than the first wireless device;
cause the network node to implement the updated prioritization order; and
cause the network node to re-implement the prioritization order after a predetermined amount of time.

13. The system of claim 9, further caused to:
determine, based on location data of the wireless device, that the wireless device is entering a predefined geographic area;
cause the network node to increase a position of the wireless device on the prioritization order when the location data indicates that the wireless device is located in the predefined geographic area; and
cause the network node to return the wireless device to a previous position on the prioritization order when the location data indicates the wireless device is located outside the predefined geographic location.

14. The system of claim 9, further caused to:
determine, based on key performance indicator data on the network node, an actual bandwidth demand above the predicted bandwidth demand; and
cause the network node to increase a position of the wireless device on the prioritization order.

15. The system of claim 9, wherein predicting the bandwidth demand on the first network slice further causes the system to:
receive key performance indicator data from the network node that is indicative of the bandwidth demand on the first network slice,
wherein the key performance indicator data relates to latency, signal strength, packet loss, or interference levels experienced by the at least one wireless device; and
compare the received key performance indicator data to historical key performance indicator data.

16. The system of claim 9, further caused to:
update the prioritization order based on a change to the predicted bandwidth demand on the first network slice.

17. A method comprising:
determining a user association of a wireless device connected to a first network slice on a network node of a telecommunication network;
predicting, using a machine learning model, a bandwidth demand on the first network slice;
generating a prioritization order for the wireless device based on the user association of the wireless device and the predicted bandwidth demand on the first network slice;
causing the network node to implement the prioritization order; and
causing the network node to provision the wireless device to a second network slice when the predicted bandwidth demand or an actual bandwidth demand exceeds an amount of available bandwidth on the first network slice.

18. The method of claim 17, further comprising:
assigning the wireless device a highest priority on the first network slice; and
causing the network node to provision the wireless device to the second network slice of the network node when the predicted demand reaches a threshold value,
wherein the threshold value is less than a total amount of resources available on the network slice.

19. The method of claim 17, wherein the wireless device is a first wireless device, the method further comprising:
generating an updated prioritization order,
wherein, in the updated prioritization order, a second wireless device has a higher position on the prioritization order than the first wireless device;
causing the network node to implement the updated prioritization order; and
causing the network node to re-implement the prioritization order after a predetermined amount of time.

20. The method of claim 17, further comprising:
determining, based on location data of the wireless device, that the wireless device is entering a predefined geographic area;
causing the network node to increase a position of the wireless device on the prioritization order when the location data indicates that the wireless device is located in the predefined geographic area; and
causing the network node to return the wireless device to a previous position on the prioritization order when the location data indicates the wireless device is located outside the predefined geographic location.
